(19) United States
(12) Patent Application Publication
(10) Pub. No.: US 2026/0288530 A1
(43) Pub. Date: Sep. 24, 2026

(54) USING SHARED NEURAL PROCESSING UNIT RESOURCES FOR WORKLOAD FULFILLMENT

(71) Applicant: Dell Products L.P., Round Rock, TX (US)

(72) Inventors: RUWAN ASANKA WASALA, Limerick (IE); JEANNIE FITZGERALD, Ennis (IE); ONUR CELEBIOGLU, Austin, TX (US)

(21) Appl. No.: 19/085,596

(22) Filed: Mar. 20, 2025

(51) Int. Cl. G06F 9/50

(52) U.S. Cl. CPC G06F 9/5044; G06F 9/5038; G06F 9/5066

(57) ABSTRACT

Methods and systems for managing shared computing resources of data processing systems are disclosed. The shared computing resources include Natural Processing Unit (NPU) computing resources configured for execution of artificial intelligence (AI) related workloads, and the NPU computing resources being provided by one or more NPUs installed in each of the data processing systems where the NPU computing resources may be registered as being idle. Workloads completed by these shared computing resources may recorded in an immutable manner to provide increased transparency, traceability, and accuracy for the processes and components that were used to complete the workloads.

### FIELD

Embodiments disclosed herein relate generally to use of neural processing units (NPUs). More particularly, embodiments disclosed herein relate to systems and methods for managing shared NPU resources of NPUs installed in one or more data processing systems (e.g., computing devices) for fulfillment of one or more workloads (e.g., artificial intelligence (AI) based workloads) using the shared NPU resources.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIGS. 2A and 2B show data flow diagrams in accordance with one or more embodiments.

embodiments.

FIG. 3 shows a flowchart in accordance with one or more embodiments.

FIG. 4 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

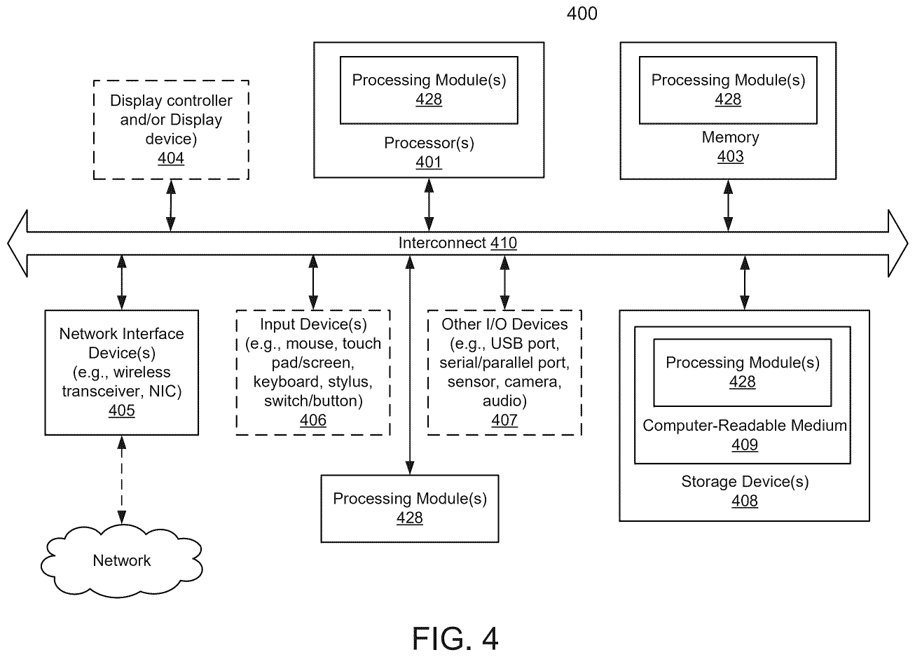

In general, embodiments disclosed herein relate to methods and systems for managing shared resources (namely, shared computing resources such as storage, processing resources, or the like) of data processing systems (e.g., computing devices, as described below in reference to FIG. 4) for the fulfillment of one or more workloads (e.g., computer-related tasks, projects, or the like) associated with users of the data processing systems.

More specifically, as artificial intelligence (AI) based technologies continue to advance, special processing units (e.g., graphical processing units (GPUs), NPUs, or similar computer chips) dedicated for AI tasks (e.g., machine learning/AI model training, machine learning/AI model execution, or the like) are developed to ease the burden on existing computing processing units (CPUs) of data processing systems.

For example, an NPU is a dedicated processor or processing unit on a larger system on a chip (SoC) designed specifically for accelerating neural network operations and AI tasks. Unlike general-purpose CPUs and GPUs, NPUs are optimized for a data-driven parallel computing, making them highly efficient at processing massive multimedia data like videos and images and processing data for neural networks. They are particularly adept at handling AI-related tasks, such as speech recognition, background blurring in video calls, Natural Language Processing (NLP) tasks (e.g., interpreting machine generated data into formats comprehensible to humans, data anonymization, natural language-based prompt enhancement, or the like), and photo or video editing processes like object detection. Additionally, NPUs are integrated circuits but they differ from single-function ASICs (Application-Specific Integrated Circuits). While ASICs are designed for a singular purpose (such as mining bitcoin), NPUs offer more complexity and flexibility, catering to the diverse demands of network computing. NPUs achieve this through specialized programming in software or hardware, tailored to the unique requirements of neural network computations.

In some cases (e.g., in consumer based electronic cases or the like), an NPU may be integrated into the main CPU of a data processing system while in other cases (e.g., at larger data centers or more specialized industrial operations or the like), the NPU might be an entirely discrete processor (e.g., separate from any other processing units) installed on a motherboard of the data processing system.

However, it is well known that the processing (e.g., execution) of AI based workloads is very power intensive (e.g., AI based workloads consume a lot of electricity), which in turn is not very environmentally friendly and has raised several environmental-related concerns by not only activist groups but also by the government and private corporations. Furthermore, since NPUs are specifically designed to implement AI related tasks, an NPU of a data processing system may have more idle time than the CPU of the same data processing system. In particular, while no AI related tasks are being implemented or scheduled, the CPU may be busy executing other processes (e.g., the operating system, non-AI related applications, or the like) while the NPU sits idle. While the NPU sits idle, the computing resources of the idle NPU sits wasted.

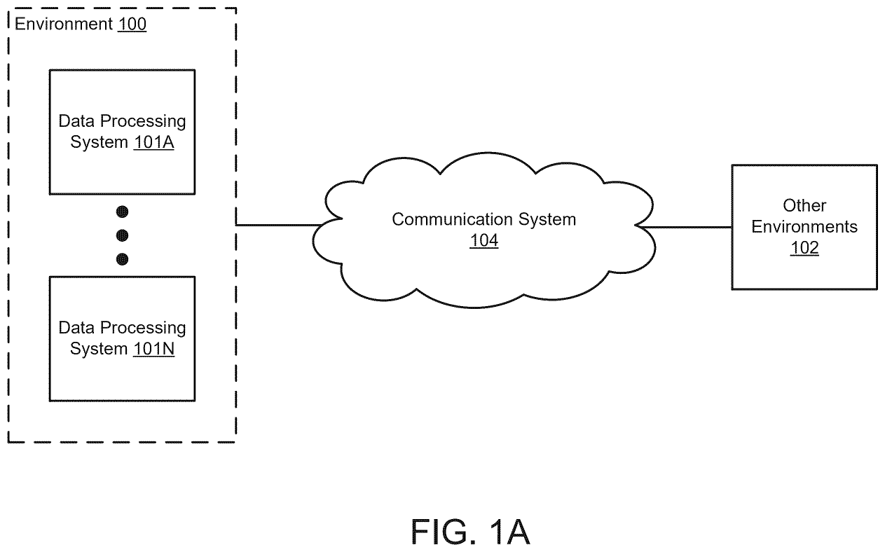

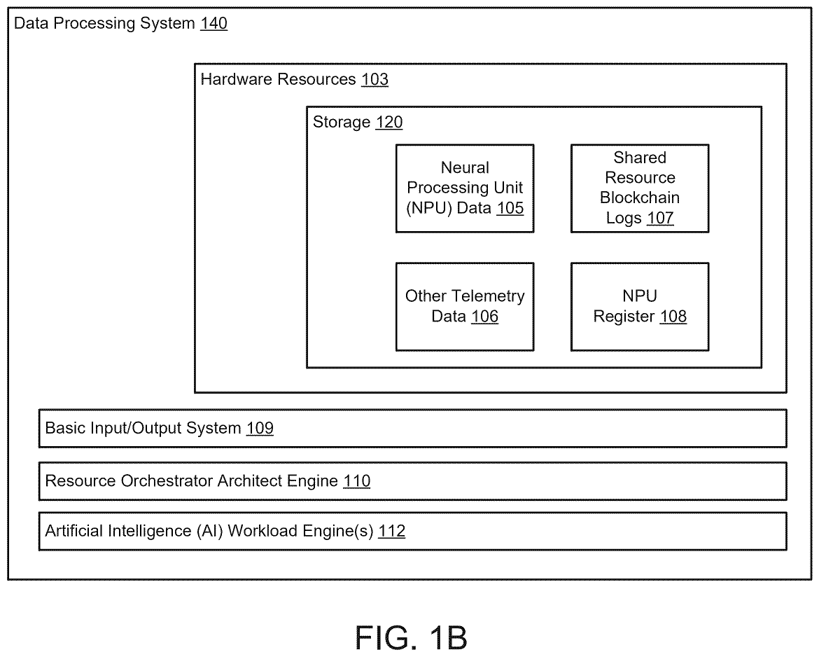

Because NPUs are much more expensive, may consume more power (e.g., electricity) than other types of processing units (e.g., CPUs, GPUs, or the like), and are more difficult to obtain than these other types of processing units, more effective (namely, resource-wise, power consumption-wise, cost-wise, or the like) use of these NPUs is generally desired. Thus, embodiments disclosed herein utilize such idle periods of NPUs for execution of tasks that users and/or data processing system may not need but could find helpful (e.g., helpful for the user and helpful for improving the functionalities of the data processing system). Embodiments disclosed herein also utilize other avenues (discussed in more detail below in reference to FIGS. 1A-4) to attempt to provide the most effective and eco-friendly use of these NPUs based on each user's needs and preferences.

One such avenue for more effective (and improved) use of these NPUs is in a shared system environment where computing resources (e.g., these NPUs'processing resources) are shared between users, in a network based (e.g., distributed system based) or on-premises, private/local based manner. For example, an ecosystem (e.g., the shared system environment) may be set up around these idle (and/or non-idle) NPU resources to capitalize and leverage the unused processing capabilities of these NPUs. In particular, idle NPUs may be made available as decentralized, crowd-sourced powerhouses for handling complex multi-agent tasks (namely, complex AI based workloads such as interpreting machine generated data into formats comprehensible to humans, data anonymization, natural language-based prompt enhancement, or the like). As a result, embodiments disclosed herein advantageously provide a platform that enables users within the shared system environment to use (e.g., with or without monetary consideration) unused or idle NPU capacity in a non-intrusive, optimized, and environmentally friendly manner.

Additionally, to use such shared NPU resources even more effectively while also improving the functionalities of the data processing systems hosting these NPUs, embodiments disclosed herein also utilize a blockchain-based, fully transparent mechanism for task cost computation that integrates environmental impact assessments. Such an approach using the blockchain-based, fully transparent mechanism not only guarantees complete traceability of computational costs (e.g., related to each workload being fulfilled) but also promotes the eco-friendly management of alternative/extra workloads through the optimized use of idle NPU resources. Thus, enhanced efficiency of workload processing/fulfillment (e.g., improved use of the computing resources that directly improves the functionality of these data processing systems being shared) and improved, minimal environmental impact are advantageously achieved.

In particular, embodiments disclosed herein incorporate blockchain technology to maintain a transparent and immutable record of workload (e.g., task) allocations and resource (e.g., NPU resources and/or other resources) utilization. This integration not only ensures traceability and accountability but also enhances the security of the shared ecosystem by providing a verifiable ledger of all events related to computing resource usage as well as actions taken by one or more agents/programs that orchestrate (e.g., manage) the assignment and processing of such workloads. Moreover, the blockchain ledger also captures detailed task information along with their environmental impact, allowing eco-friendly practice verification. As such, an improved shared system environment (e.g., shared computing resource environment) may be obtained, which also translates to a direct improvement to workload distribution (e.g., within distributed environments) related technology (namely, over those that do not use such blockchain inspired approaches and/or over those that do not provide any traceability of resources being used and processes being executed).

Other advantages, improvements to various computer-related technologies and improvements to computer functionalities will be apparent below as more details regarding embodiment disclosed herein are described in reference to the figures (e.g., FIGS. 1A-4).

In an embodiment, a method for managing shared computing resources of data processing systems is provided. The method may be performed by a first data processing system of the data processing systems and may include: obtaining a workload request; performing a workload assignment process using one or more workload assignment factors to obtain workload instructions and at least one data processing system of the data processing systems to which the workload request is to be assigned, the one or more workload assignments factors being obtained at least from: a smart contract stored on a blockchain, and resource orchestration architect agents deployed across the data processing systems; and causing, by the first data processing system and through providing the workload instructions to the at least one data processing system, the at least one data processing system to fulfill the workload request.

The shared computing resources comprise Natural Processing Unit (NPU) computing resources configured for execution of artificial intelligence (AI) related workloads, the NPU computing resources being provided by one or more NPUs installed in each of the data processing systems.

The NPU computing resources are registered as being idle.

The one or more workload assignment factors comprise an environmental impact associated with execution and completion of a workload specified in the workload request by the at least one data processing system.

The environmental impact is quantified based on an amount of energy consumption and an estimated carbon dioxide emission required for the execution and completion of the workload.

The one or more workload assignment factors further comprise a skill assessment of each of the one or more NPUs.

The one or more workload assignment factors further comprise optimization requirements specified in the workload request, the optimization requirements being defined by a user associated with the workload request and comprise requirements based on at least speed, accuracy, and environmental impact associated with the execution and completion of the workload.

The smart contract dynamically performs real-time adjustments to one or more factors used to determine the environmental impact and provides the one or more factors that are adjusted in real-time to the first data processing system while the first data processing system is performing the workload assignment process.

The method may further comprise: obtaining, from the at least one data processing system, a workload completion notice comprising workload completion data; and archiving the workload completion data onto the blockchain.

The workload completion data that is archived onto the blockchain comprises a description of a workload completed by the at least one data processing system, an amount of and identification (ID) information of hardware resources associated with the shared computing resources used by the at least one data processing system to complete the workload, and an environmental impact factor associated with completion of the workload.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

Turning to FIG. 1A, a block diagram illustrating a system in accordance with an embodiment is shown. The system shown in FIG. 1A may provide computer implemented services. The computer implemented services may include any type and quantity of computer implemented services. For example, the computer implemented services may include data storage services, instant messaging services, database services, AI/ML services and/or any other type of service that may be implemented with a computing device.

To provide the above noted functionality, the system of FIG. 1A may include any number of data processing systems 101A-101N that make up a computing environment 100. Computing environment 100 may be any type of environment (e.g., a deployment, a remote server, a corporation's office, a single user, a distributed system, or the like) where one or more of the data processing systems 101A-101N may be hosted and used to provide computer implemented services to one or more users.

Each data processing system 101A-101N may be a node within the computing environment 100. One or more nodes may then be combined and/or arranged into one or more clusters (e.g., one or more groups of data processing systems), each of which having at least one of the nodes. Additionally, data processing systems 101A-101N may provide the computer implemented services to users of data processing systems 101A-101N and/or to other devices (not shown). Different data processing systems may provide similar and/or different computer implemented services.

To provide the computer implemented services, data processing systems 101A-101N may include various hardware components (e.g., various types of processors, memory modules, storage devices, etc.) and host various software components (e.g., operating systems, application, machine learning model, startup managers such as basic input-output systems, etc.). These hardware and software components (discussed in more detail below in FIG. 1B) may provide the computer implemented services via their operation.

The software components may be implemented using various types of services. For example, each data processing system of the data processing systems 101A-101N may host various services that provide the computer implemented service (e.g., application services, data anonymization services, data verification services, or the like) and/or that manage the operation of these services (e.g., management services). The aggregate (e.g., combination) of the management and application services may be a complete service that provide desired functionalities.

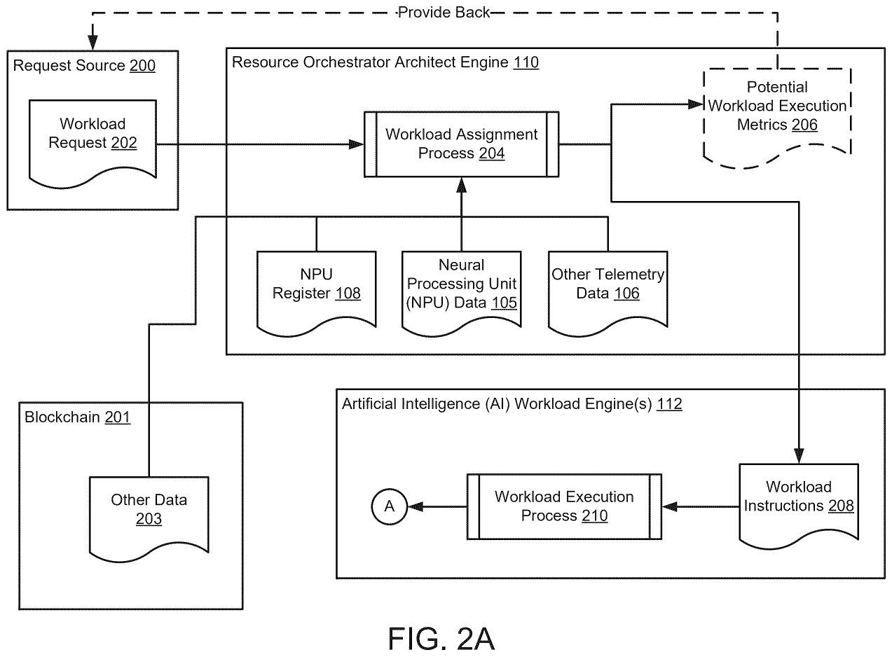

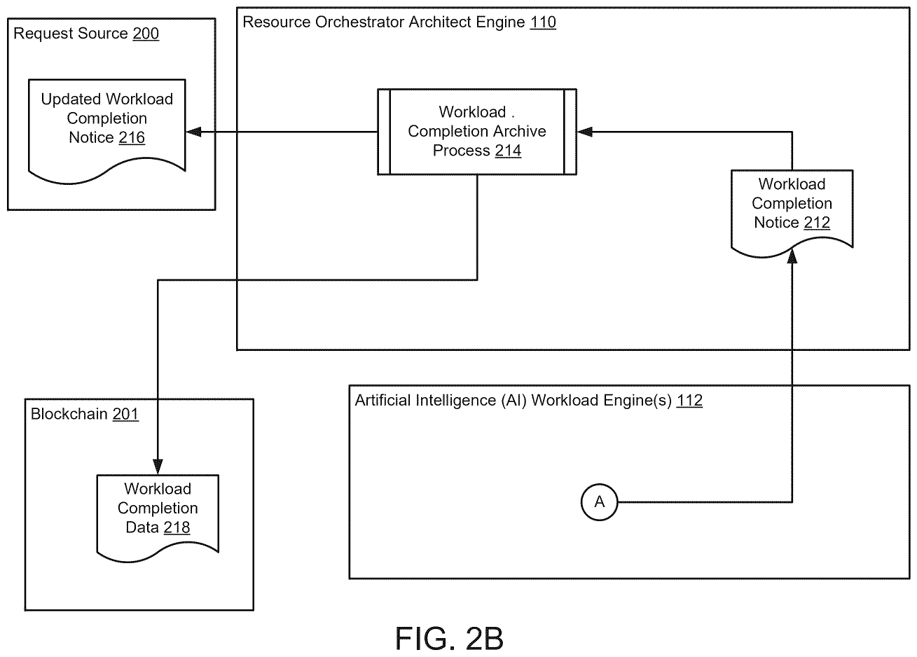

Any of the components illustrated in FIG. 1A may be operably connected to each other (and/or components not illustrated) with communication system 104. In an embodiment, communication system 104 includes one or more networks that facilitate communication between any number of components (e.g., computing environment 100 with other environments 102 (e.g., other environments over the network that are similar to environment 100). The networks may include wired networks and/or wireless networks (e.g., and/or the Internet). The networks may operate in accordance with any number and types of communication protocols (e.g., such as the Internet Protocol). For example, the data processing systems 101A-101N may be combined with data processing system(s) making up the other environments 102 to create an even larger distributed system with even better capabilities for computing resource sharing (as discussed in more detail below in FIGS. 2A-2B).

In embodiments, within the computing environment 100, the data processing systems 101A-101N may be connected via a local area network (LAN) based protocol to form an intranet setting between the data processing systems 101A-101N. For example, assume that environment 100 is now isolated (e.g., disconnected) from the communication system 104), such an isolated version of the environment 100 may be set up to implement the on-premises, private/local shared system environment version of embodiments disclosed herein where the data processing systems 101A-101N making up environment 100 are grouped together to distribute their workload capacity for more efficient use of computing resources (e.g., NPU resources, or the like), offering a local environment that is advantageously less dependent on cloud-based services for access to computing resources used to fulfill all of the workloads required to be fulfilled within environment 100.

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems 101A-101N and/or any other data processing system located within (e.g., making up) any of the other environments 102 shown in FIG. 1A.

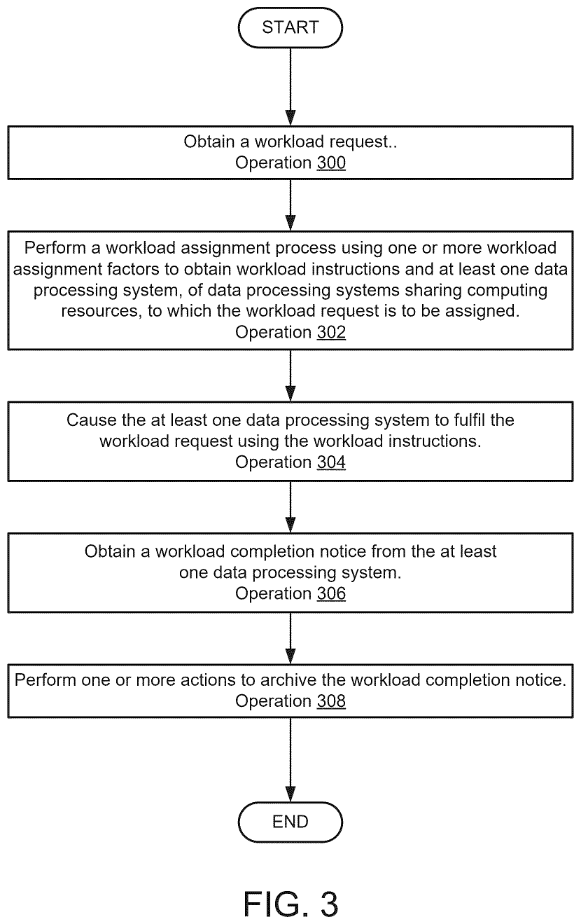

To provide computer implemented services (e.g., any of the services discussed above in reference to FIG. 1A, the processes and methods associated with embodiments disclosed herein as discussed in reference to FIGS. 2A-3, or the like), data processing system 140 may include any quantity of hardware resources 103. Hardware resources 103 may include physical parts of data processing system 140 that store and run software. Hardware resources 103 may include processors (e.g., CPUs, GPUs, NPUs), memory modules (also referred to herein as “memory devices”), storage devices, and/or other types of hardware components usable to provide computer implemented services. A basic input/output system (BIOS) 109 may be stored on the processors and memory modules.

Storage 120 may be implemented using any combination of storage devices (e.g., hard disk drives (HDDs), solid state drives (SSDs), volatile memory, non-volatile memory, or the like). Storage 120 may be configured to store at least neural processing unit (NPU) data 105, other telemetry data 106, shared resource blockchain logs 107, and one or more NPU registers 108.

In embodiments, NPU data 105 may contain any type of data associated with one or more NPUs that are installed within data processing system 140. Said another way, any type of information associated with the NPUs of (i.e., physically installed within) data processing system 140) may be recorded within and stored as NPU data 105. Namely, NPUs can have different and unique features and architectures suited to specific processing (e.g., AI) requirements. Thus, it is important that such different and unique features be recorded so that they can be shared between the various data processing systems that will eventually be (or is already) forming a distributed system for sharing computing resources. This advantageously allows each data processing system within the distributed system to understand the capabilities and functionalities of the NPUs of the other data processing systems.

NPU related information that may be included in the NPU include, but is not limited to: (i) basic raw attributes of the NPU(s) including system specification, manufacturer information, unique identification (ID), model information, model cards, versions, input-output (I/O) specifications, or the like; (ii) skills associated with each NPU (e.g., what programs, applications, and/or machine learning models or the like are hosted on each NPU) such as text to text conversion, data anonymization, image generation, or the like; (iii) certifications associated with each NPU (e.g., are any of the programs, applications, and/or machine learning models or the like are hosted on each NPU certified or contain a certification); (iv) performance benchmarking of each NPU; (v) NPU specific usage metrics; (vi) task/skilled agent/compute specifications of each NPU including details of skilled agents (associated with programs, applications, and/or machine learning models or the like are hosted on each NPU), task complexity ratings associated with tasks/workloads that each NPU has processed (e.g., fulfilled, executed, or the like) or is capable of processing, NPU resources utilized (e.g., type, time, memory, or the like), and agent/model efficiency metrics or the like; (vii) idle time associated with each NPU; or the like.

Any other type of information associated with each locally NPU installed within the data processing system 140 may be included in NPU data 105 without departing from the scope of embodiments disclosed herein.

In embodiments, other telemetry data 106 may include all other types of data (besides NPU specific data) associated with data processing system 140. Such data may include any type of performance and/or non-performance related data such as: (i) hardware and/or software component information of the data processing system 140; (ii) non-NPU related computing resources (e.g., CPU resources, GPU resources, memory resources, etc.) available within data processing system 140, system logs (e.g., event logs, error logs, or the like); (iii) owner information including owner ID of the data processing system 140; (iv) operating state information of the data processing system 140; (v) network latency information; or the like).

Any other type of performance based and/or non-performance-based information associated with data processing system 140 may be included in other telemetry data 106 without departing from the scope of embodiments disclosed herein.

In embodiments, shared resource blockchain logs 107 may include any type of information associated with a workload completed by at least one NPU that is physically and locally installed within data processing system 140. For example, shared resource blockchain logs 107 may include any of the information included in NPU data 105. Shared resource blockchain log 107 may also include, in addition to any of the NPU data 105: (i) environment impact data that quantifies an environment impact associated with the completed workload; (ii) any forms of incentives (e.g., payments, rewards, bonuses, or the like) associated with the completed workload. Other information and/or data associated with completion of the workload (e.g., any of the information and/or data included in other telemetry data 106, or the like) may also be included in shared resource blockchain logs 107 without departing from the scope of embodiments disclosed herein.

Each instance of the shared resource blockchain log 107 may be temporarily stored in storage 120 until each instance is uploaded onto a blockchain environment that is associated with the shared computing environment (e.g., a blockchain that is accessible by all of the members of the distributed environment making up the shared computing environment) of embodiments disclosed herein. In embodiments, before each instance of the shared resource blockchain log 107 is uploaded (e.g., added) to the blockchain environment, a verification process (e.g., by resource orchestrator architect engine 110 discussed below, or the like) may be undertaken (e.g., performed) by, for example, cross-referencing information such as timestamp and specification data with logs (e.g., activity logs, operating system (OS) logs) of the data processing system(s) 140 that fulfilled/processed the workload documented in each instance of the shared resource blockchain log 107 (e.g., using their respective NPUs and other computing resources) in order to guarantee an accuracy and truthfulness of the information recorded within each instance of the shared resource blockchain log 107. Other (e.g., different, additional, or the like) verification processes for verifying each instance of the shared resource blockchain log 107 may also be employed without departing from the scope of embodiments disclosed herein.

Essentially, each instance of a shared resource blockchain log 107, once uploaded to the blockchain environment, may serve as an immutable record (e.g., ledger) of every workload (e.g., task) processed within the shared computing environment of embodiments disclosed herein. For example, upon completion of a workload, all information associated with the workload (e.g., including all key workload metrics starting from task configuration and assignment, resource usage, NPU activity, everything relating to transactions (e.g., monetary and/or non-monetary) within shared computing environment, and ending with a result of the workload fulfillment/processing, or the like) may be compiled into one instance of shared resource blockchain log 107 and the compiled instance of the shared resource blockchain log 107 may be appended to a chain of these logs that already exist within the blockchain environment (e.g., as another block within blockchains of this blockchain environments). This approach using the blockchain ledger advantageously provides improved transparency and accountability of the resource allocation and workload fulfillment processes being handled by one or more processes (e.g., manual and/or automatic processes) within the shared computing environment.

In embodiments, NPU register 108 may be a register (e.g., list, database, ledger, or the like) storing all of the available NPUs (along with their respective information and capabilities, as included in NPU data 105) within one shared computing system of embodiments disclosed herein. Within the NPU register 108, the NPUs may be grouped in any form/manner (e.g., one or more groups may be created based on the data modalities associated with the skills/capabilities of each NPU such as an image processing group, a video processing group, a voice/audio processing group, a text processing group, or the like). As another examples, groups may also be created based on the specific type of tasks (e.g., AI based tasks such as interpreting machine generated data into formats comprehensible to humans, data anonymization, natural language-based prompt enhancement, or the like) that each NPU has been configured to perform.

The first time an NPU is registered within NPU register 108, the NPU may be caused (e.g., by resource orchestrator architect engine 110 discussed below, or the like) to undergo an evaluation against a set of pre-stored, user-defined benchmark tasks to assess the NPU's performance and record e.g., within the NPU register 108 and/or within NPU data 105) relevant performance metrics, resource use, efficiency, energy consumption, computer requirements, and other similar statistics/parameters.

NPU register 108 may also include information regarding NPUs within the shared computing system of embodiments disclosed herein that are idle (e.g., in an idle state of not being used for any processes/workloads/tasks). Such idle indication may be: (i) determined, inferenced, and/or predicted (e.g., by resource orchestrator architect engine 110 discussed below, or the like) using any of the above-listed NPU performance information and/or any information stored within NPU data 105; (ii) be determined based on registration of an NPU as idle by a user of data processing system 140 (e.g., a user of data processing system may actively register an NPU as being idle by providing information such as an NPU idle calendar including start and end dates of the idle period and/or hours of the day during the NPU is expected to be idle, or the like); or any other suitable methods. Just as idle NPUs may be registered by users, registered idle NPUs may also be deregistered (e.g., removed from NPU register 108) by the users.

For improved traceability and accuracy within the network version of the shared computing environment of embodiments disclosed herein, the NPU idle information provided by the user may be recorded (e.g., appended) on the blockchain environment (e.g., with agreed terms and conditions for use of the idle NPUs documented within one or more smart contracts stored on the blockchain environment, or the like). For the on-premises, private/local version of the shared computing environment of embodiments disclosed herein, the NPU idle information may be locally managed and stored (e.g., in one central location, distributed across various data processing systems, or the like).

The information (e.g., the capability and availability, or the like, information) of each NPU within each NPU register 108 may be stored in any format (e.g., within one or more organized and searchable tables, list, or the like) without departing from the scope of embodiments disclosed herein.

BIOS 109 may be used to startup data processing system 140. On the startup, BIOS 109 may configure peripheral devices, such as a keyboard, mouse, monitor, etc. With the peripheral devices, BIOS 109 may configure hardware resources 103 for use by data processing system 140. BIOS 109 may also generate any of the logs (e.g., computer logs) to be stored in other telemetry data 106.

Resource orchestrator architect engine 110 may be implemented using hardware, software, or a combination thereof. For example, resource orchestrator architect engine 110 may be configured using one or more trained machine learning models (e.g., inference models, regression models, generative AI models, or the like and any combination thereof) that are pre-trained (e.g., using any appropriate machine learning model training method including any combination of Deep Reinforcement Learning (DRL) based techniques, Reinforcement Learning from Human Feedback (RLHF), or the like) to be muti-modal agents (e.g., models), specialized in the precise allocation and assessment of NPU (other similar) resources for workload execution (e.g., fulfillment) within the shared computing system of embodiments disclosed herein.

For example, resource orchestrator architect engine 110 may be trained on any of the NPU data 105, other telemetry data 105, shared resource blockchain logs 107, NPU register 108, or any other data obtained from internal and/or external data (e.g., web text corpora with mostly user-generated content, or the like). Additionally, resource orchestrator architect engine 110 of data processing system 140 may be trained to interact (e.g., exchange information with other resource orchestrator architect engines 110 of other data processing systems within the same shared computing system) to dynamically update the NPU register 108. Further, resource orchestrator architect engine 110 of data processing system 140 (or any other processing units of data processing system 140) may be trained to dynamically update NPU data 105 and other telemetry data 106 and to generate shared resource blockchain logs 107.

More specifically, in embodiments, resource orchestrator architect engines 110 within the same shared computing system may coordinate tasks among each other and operate within a distributed network manner where the resource orchestrator architect engines 110 are programmed/trained to continuously monitor and analyze the status of each individual NPU (or other computing resource) within the same shared computing system. Each resource orchestrator architect engine 110 may utilize permanently allocated resources (e.g., high-performance GPUs installed within the data processing systems in which each resource orchestrator architect engine 110 is hosted) to run their operations. Through operating system integrations (e.g., through operation of BIOS 109, or the like), these resource orchestrator architect engines 110 may receive real-time data related to all NPUs within the shared computing system, encompassing any of the information stored/available in NPU data 105, other telemetry data 106, shared resource blockchain logs 107, and/or NPU register 108.

For example, an initial setup/training phase for each resource orchestrator architect engines 110 may include causing the resource orchestrator architect engines 110 to perform a detailed assessment of the topology of the shared computing system and of the NPUs and hardware profiles (of the data processing systems) thereof. This process advantageously enables the resource orchestrator architect engines 110 to achieve a deep understanding of the specifications, capabilities, and capacities of, e.g., the NPUs across the shared computing system. More specifically, resource orchestrator architect engines 110 may monitor NPU resource and energy usage within the shared computing system for a configurable observatory and pre-assessment time (e.g., a monitoring phase). Resource orchestrator architect engines 110 may also track typical workload and processing times to identify patterns. Such analysis helps the resource orchestrator architect engines 110 determine how NPUs in the shared computing system can be best utilized to perform additional compute workloads/task during the NPU's idle and/or non-idle times. Even further additional context such as public and employee holiday schedules can be leveraged together with the information available within NPU register 108 to allow the resource orchestrator architect engines 110 to (through working individually or together as a team) identify optimal opportunities for reallocating underutilized compute resources (e.g., underutilized NPU resources, or the like) for additional workloads.

Following the monitoring phase, resource orchestrator architect engines 110 may employ advanced pattern recognition techniques to model typical NPU (or other computing resource) usage trends within the shared computing system of embodiments disclosed herein. This modelling serves as the basis for predictive planning, advantageously enhancing the ability to forecast future computing resource availability within the shared computing system. Through continuous data collection, analysis, and training, resource orchestrator architect engines 110 may refine their understanding, enabling the optimization of task allocation based on factors (e.g., workload assignment factors) such as real-time performance metrics, cost considerations, or the like. Additional details of such optimization of task allocation based on factors is discussed below in reference to FIGS. 2A-2B.

With their advanced multi-model capabilities, the resource orchestrator architect engines 110 are advantageously adept at interpreting NPU telemetry and orchestrating a diverse range of tasks, thereby establishing high, improved efficiency and specialization in NPU resource management. This distinctive to network resource management using the resource orchestrator architect engines 110 of embodiments disclosed herein further ensures the optimal utilization of NPUs, minimizing idle times while maximizing computational throughput across complex AI workloads through, for example, the resource orchestrator architect engines 110 utilization of: (i) real-time data for informed, adaptive decision-making on NPU use for dynamic workload allocation; (ii) predictive planning and AI/ML patten recognition for forecasting NPU trends, improving task allocation efficiency; and (iii) refining workload and environmental costs using reinforcement learning feedback loop, continually refining energy-efficient AI workload and NPU resource allocation strategies; or the like.

AI workload engines 112 may be implemented using hardware, software, or a combination thereof. In embodiments, each AI workload engine 112 may be a trained machine learning model (e.g., a regression model, a large language model (LLM), a generative AI model, a GPT model, or the like), with its respective agent (e.g., an application programming interface (API), or the like), that is implemented (e.g., hosted) on the locally installed NPU(s) of the data processing system 140. For example, each AI workload engine 112 may be a trained machine learning model that is trained (e.g., configured) to perform (e.g., execute) at least one (or a combination thereof) of AI based workloads such as, but not limited to: (i) data anonymization as-a-service (aaS); (ii) conversion of machine generated data (e.g., raw telemetry data) into human readable data; (iii) assembling teams of the AI workload engines 112 for a workload; (iv); classical AI/ML classification and/or regression; (v) fraud/anomaly detection; (vi) image processing and generation; (vii) optimization related tasks; (viii) inference generation; (ix) neural architect search; (x) hyper parameter tuning; (xi) LLM specific tasks; or the like.

AI workload engines 112 may receive workload assignments from one or more of the resource orchestrator architect engines 110 within the shared computing system and execute (e.g., fulfill) the received workload assignments. For example, upon deployment of workload assignments by resource orchestrator architect engine 110, one or more of the AI workload engines 112 that received the workload assignments may commence the processing (e.g., fulfillment) of the assigned workload assignments (e.g., on specified NPU resources). In particular, each AI workload engine 112 may be equipped with advanced capabilities and may collaborate to efficiently complete the assigned workload assignments. For group tasks, specialized team(s) of AI workload engines 112 (e.g., as registered in NPU register 108) may be assembled the performance and capabilities of each of these AI workload engines 112. Upon task completion or in the event of an error, AI workload engines 112 may prompt the NPUs to log relevant details (e.g. timestamps and errors via the operating system) and report the same back to the resource orchestrator architect engines 110 to signifying, for example, task finalization or the need for intervention.

While the AI workload engines 112 are executing the assigned workload assignments, the resource orchestrator architect engine 110 may monitor (e.g., in real-time) each of the AI workload engines 112 and keep track of one or more metrics of each assigned workload assignment being executed. For example, NPU usage statistics including type and specifications of the NPU, compute time utilized, memory usage, CPU usage, and overall energy consumption may be monitored and compiled into shared resource blockchain logs 107. Telemetry data collected during workload assignment execution may also logged and recorded, which advantageously offers a more granular and improved view of resource utilization by the AI workload engines 112. As another example, resource orchestrator architect engine 110 may also calculate (e.g., generate) a task complexity value that rates each task on a pre-defined difficulty scale (e.g., a difficulty scale of 1 to 10 with one being easy and 10 being the most difficult) while also providing a standardized measure of each assigned workload's (e.g., AI workload engine's 112) computational demand.

In embodiments, the resource orchestrator architect engine 110 and the AI workload engines 112 of each data processing system 140 may be hosted on different hardware resources. For example, the resource orchestrator architect engine 110 and the AI workload engines 112 may be hosted on different NPUs of the data processing system. As another example, the resource orchestrator architect engine 110 may be hosted on the GPU while the AI workload engines 112 may be hosted on the NPU(s) of the data processing system 140. Alternatively, the resource orchestrator architect engine 110 and the AI workload engines 112 of each data processing system 140 may be hosted on the same hardware resources (of the data processing system 140).

In embodiments, not every data processing system (e.g., 101A-101N, FIG. 1A) within an environment (e.g., 100, FIG. 1A) may include resource orchestrator architect engine 110. For example, only one (or a sub-portion of) the data processing systems within an environment may include the resource orchestrator architect engine 110. Alternatively, in some embodiments, every data processing system within an environment may include an instance of resource orchestrator architect engine 110.

While FIG. 1B is illustrated as including a limited number of specific components, a data processing system in accordance with an embodiment may include fewer, additional, and/or different components than those illustrated therein. For example, in addition to all of the components shown in FIG. 1B, the data processing system 140 may also include part of all of the components of the example computing device described below in reference to FIG. 4.

To further clarify embodiments disclosed herein, data flow diagrams in accordance with embodiments disclosed herein are shown in FIGS. 2A and 2B. In the data flow diagram of FIGS. 2A and 2B, flows of data and processing of data are illustrated using different sets of shapes. A first set of shapes (e.g., 202, 108, 105, 106, 206, etc.) is used to represent data structures (e.g., files, documents, data packets, or the like), a second set of shapes (e.g., 204, 210, etc.) is used to represent processes performed using and/or that generate data, and a third set of shapes (e.g., 200, 201, 110, 112, etc.) is used to components and/or devices that perform (e.g., execute) the processes shown using the second set of shapes.

FIGS. 2A and 2B show a workload assignment (e.g., workload allocation) process within a shared computing system of embodiments disclosed herein.

Starting with and as shown in FIG. 2A, a workload request 202 may be provided from a request source (e.g., any of the data processing systems associated with any of the environments shown in FIG. 1A). Workload request may include: (i) one or more workloads to be fulfilled; (ii) a description of each of the workloads; (iii) one or more user-specified optimization requirements for each of the workloads (e.g., for optimization of factors/parameters such as speed, accuracy, privacy, environmental impact, financial costs, system rewards, or the like); (iv) one or more container images or the like including instructions and/or requirements for the execution of each of the workloads; (v) any type of information specifying computing resource costs and/or requirements of each of the workloads; or the like.

Other information that could be used to describe and/or understand the workload being requested may be included in workload request 202 without departing from the scope of embodiments disclosed herein.

For brevity, the following descriptions of FIGS. 2A and 2B will be discussed in connection with a workload request 202 that includes only a single workload to be fulfilled. However, as discussed above, the workload request 202 may include any number of workloads without departing from the scope of embodiments disclosed herein.

As shown in FIG. 2A, the workload request 202 may be provided by the request source 200 to a resource orchestrator architect engine 110 of a data processing system (e.g., 140, FIG. 1B). Once the resource orchestrator architect engine 110 receives the workload request 202, the resource orchestrator architect engine 110 may individually (or as a team with other resource orchestrator architect engines 110 of other data processing systems within the shared computing system) perform a workload assignment process 204 to assign the workload specified in the workload request 202 to, for example, one or more AI workload engines 112 within the shared computing system.

As part of workload assignment process 204, resource orchestrator architect engine 110 may analyze one or more workload assignment factors to determine which AI workload engines 112 are the optimal components for fulfilling the workload request 202 (e.g., which of the AI workload engines 112 are the optimal ones for completing the workload). The workload assignment factors may include: (i) any information available within NPU register 108; (ii) any information available within NPU data 105; (iii) any information available within other telemetry data 106; and (iv) other data 203 retrieved from a blockchain 201. Any information contained in the NPU register 108, NPU data 105, and other telemetry data 106 may be obtained locally from the data processing system hosting the resource orchestrator architect engine(s) 110 that received the workload request 202 and shared (e.g., communicated shared between the resource orchestrator architect engine(s) 110 that received the workload request 202.

In embodiments, other data 203 retrieved from the blockchain 201 may include: (i) shared resource blockchain logs 107 that have already been appended to the blockchain (e.g., as historical/past workload fulfillment data); (ii) one or more smart contracts stored on the blockchain 201; or the like. The smart contracts stored on blockchain 201 may include: (i) the smart contract discussed above in reference to FIG. 1B storing the agreed upon terms and conditions and idle information of the NPUs; (ii) smart contracts configured with dynamic adjustment capabilities that allow for the real-time re-calibration of cost parameters based on external energy and environmental pollution related cost factors (e.g., including updates on energy consumption metrics such as prevailing energy prices, environmental pollution levels (e.g., real-time carbon dioxide (CO₂) emission levels collected via data feeds), or the like); or the like.

Such one or more workload assignment factors may be used within workload assignment process 204 to also (e.g., in addition to determining the most suitable (e.g., optimal) AI workload engine(s) 112) calculate one or more workload cost and/or score values.

For example, one cost and/or score value may be an environmental impact value of the workload. The environmental impact value may include (and/or be based on) metrics such as an energy consumption cost, energy cost, CO₂ emission amount, or the like that the workload is expected, determined, estimated, or predicted to use. An example environmental impact value may be calculated using an equation of “environmental impact value=[energy consumption×energy cost]+[CO₂ emissions×environmental impact factor]+[resource efficiency score×resource efficiency constant for the shared computing system]” where: (i) energy consumption may be the overall energy use (e.g., how much electricity) the workload will use, as measured in kilowatt-hours, or the like; (ii) energy cost factor may be a quantification of how much environmental damage each kWh of electricity causes, based on how the electricity is generation (e.g., coal=0.8, solar=0.2, wind=0.1, or the like) expressed as damage/kWh; (iii) CO₂ emissions may be quantified as the amount of CO₂ produced by the fulfillment of the workload as measured in kilograms (kg); (iv) environmental impact factor may be quantified as a score that reflects how bad CO₂ is for the environment (e.g., each 1 kg CO₂=score of 0.2 points, or the like); (v) resource efficiency score may be quantified as a score computed based on telemetry data reflecting how efficiently the workload used resources (e.g., on a user defined scale of, for example, 0.0 to 1.0 with 1.0 being the most efficient); and (vi) efficiency constant for shared computing system may be quantified as a constant figure for rewarding high efficiency.

Other types and/or format of equations using similar and/or different parameters may also be used to calculate the environmental impact value without departing from the scope of embodiments disclosed herein. Additionally, each of these parameters (e.g., energy consumption, energy cost factor, CO₂ emissions, environmental impact factor, resource efficiency score, efficiency constant for shared computing system) and/or information that can be used to determine (e.g., calculate) each of these parameters may be included in any of the other data 203 (e.g., the smart contracts), the NPU register 108, the NPU data 105, and/or the other telemetry data 106.

Another cost and/or score value may be a total cost value/score (also referred to herein as a “task cost assessment”) for the workload in the workload request. The task cost assessment may be calculated using the equation of “Total cost=base cost×task complexity multiplier×skilled agent efficiency factor×NPU resource utilization factor+the environmental impact fee” where: (i) the base cost represents the primary/initial cost for commencing the workload; (ii) the complexity multiplier being a user-defined value range (e.g., between 1 to 10) that is used to adjust the base cost based on the workload's complexity (e.g., from the most straight forward workloads being 1 to the most complex workloads being 10); (iii) skilled agent efficiency factor being a user-defined value range (e.g., 0.5 to 2) that reflects the energy and operational efficiency of the AI workload engine(s) 112 (e.g., how good an AI workload engine 112 is at saving energy and working fast where the most efficient AI workload engine 112 may have a factor of 0.5 that cuts the base cost in half or where the least efficient AI workload engine 112 may have a factor of 2 that doubles the base cost); (iv) NPU resource utilization factor being a user-defined value range (e.g., 0.5 to 2) that assess the efficiency of NPU usage during the fulfillment (e.g., execution) of the workload (e.g., if the AI workload engine(s) 112 uses NPUs perfectly without waste the NPU resource utilization factor may be 0.5 to reduce the base cost, or if the AI workload engine(s) 112 uses the NPUs extremely poorly the NPU resource utilization factor may be 2 to double the base cost); (v) the environmental impact fee being the above-discussed environmental impact value calculated using the separate equation (or that could be directly provided by a user or the like).

Other types and/or format of equations using similar and/or different parameters may also be used to calculate the task cost assessment without departing from the scope of embodiments disclosed herein. Additionally, each of these parameters (e.g., base cost, complexity multiplier, skilled agent efficiency factor, NPU resource utilization factor, environmental impact fee) and/or information that can be used to determine (e.g., calculate) each of these parameters may be included in any of the other data 203 (e.g., the smart contracts), the NPU register 108, the NPU data 105, and/or the other telemetry data 106.

In embodiments, the resource orchestrator architect engine(s) 110 may calculate the environmental impact value and the task cost assessment at any timing during the workload assignment process 204. For example, the resource orchestrator architect engine(s) 110 may calculate these two values prior to actually selecting the actual AI workload engine(s) 112 to be used. More specifically, the resource orchestrator architect engine(s) 110 may calculate these two values using predicted to be used ones of the AI workload engine(s) 112 based on analysis of information and data (e.g., the NPU register 108, the NPU data 105, the other telemetry data 106, and the other data). Alternatively, the resource orchestrator architect engine(s) 110 may generate a plurality of these values based on selecting a top N number of AI workload engine(s) 112 suitable for the workload where N can be any positive whole number. As another alternative, the resource orchestrator architect engine(s) 110 may calculate these two values only after selecting the actual AI workload engine(s) 112 to be used. Additionally, any or all of the values calculated at any of the above timings may be presented (e.g., in potential workload execution metrics 206).

In embodiments, after determining (e.g., calculating) the AI workload engine(s) 112 to be used, the resource orchestrator architect engine(s) 110 may (optionally) generate potential workload execution metrics 206 including these two values and (again optionally) present potential workload execution metrics 206 to the request source 200. Additional information (e.g., any other performance values, metrics, or the like) that could help a user that transmitted the workload request 202 from request source 200 better understand details about how the workload will be executed (e.g., fulfilled) may also be included in potential workload execution metrics 206. This may include information such as: (i) a timing of when the workload will be completed; (ii) which AI workload Engine(s) 112) will be used and/or are selected; (iii) the environmental impact value and the task cost assessment; and other similar data/information already discussed above in reference to FIGS. 2A and 1B. Additionally, the resource orchestrator architect engine(s) 110 may use the environmental impact value and/or the task cost assessment to calculate (e.g., using one or more predefined/pre-stored incentives equation) one or more monetary and/or non-monetary incentives (e.g., access to NPU resources that were previously locked to this user, digital currencies such as reward points or the like, or the like) that the user may receive after the workload is completed.

Presenting the potential workload execution metrics 206 advantageously allows the user that submitted the workload request 202 to be able to make an informed decision as to whether the user wants to continue with the fulfillment (e.g., execution) of the workload or to terminate the workload. In particular, embodiments disclosed herein (e.g., through ensuring fairness and transparency) encourages users to shift toward more energy-efficient computing and optimized NPU usage through the alignment of, for example, cost benefits with environmentally friendly computing practices. Thus, for example, if a workload generates no incentives at all for the user, the user may wish to terminate the workload before the workload is actually executed (e.g., fulfilled).

As another (e.g., additional) part of workload assignment process 204 (that could result in a change in the information presented in potential workload execution metrics 206), the resource orchestrator architect engine(s) 110 may also use the one or more user-specified optimization requirements included in workload request 202 to determine the best (e.g., optimal) AI workload engine(s) 112 for completing (e.g., fulfilling) the workload request 202.

For example, in some embodiments, a strategic approach to optimizing resource allocation and task scheduling within the shared computing system (e.g., using reinforcement learning, or the like) may be applied by the resource orchestrator architect engine(s) 110. In particular, as volume and variety of workloads are submitted to and executed in the shared computing system, the resource orchestrator architect engine(s) 110 may be given (e.g., provided with) both the environmental impact value and task cost assessment (of each completed workloads) as reinforcement learning feedback to make better-informed decisions in the future on resource allocation and task scheduling. This may involve, for example, identifying and repeating patterns for executing workloads with high energy efficiency or at times of lower carbon intensity. Over time, this strategic approach fosters an ecosystem where tasks are not only cost-efficient but also environmentally sustainable. In such a situation, the desired outcome might have more-or-less weight on financial cost versus privacy cost versus environmental cost (for example)—depending on the workload/user. There can be even more objectives attached to user preference such as faster execution (e.g., preferred date vs deadline), selection of specific AI workload engine(s) 112, or the like, resulting in a shared computing system where the resource orchestrator architect engine(s) 110 are capable of creating a self-optimizing network of computing resources (e.g., NPU resources) that dynamically allocate resources on need basis, establishing a “pre-active” state of readiness.

Turning back to FIG. 2A, once approval to continue is received from the user (or automatically by the resource orchestrator architect engine(s) 110 without soliciting feedback from the user), the resource orchestrator architect engine(s) 110 may generate workload instructions 208 (e.g., from workload assignment process 204) and provide (e.g., transmit) the workload instructions 208 to one or more AI workload engine(s) 112. The AI workload engine(s) 112 that receive the workload instructions 208 are those that were selected by the resource orchestrator architect engine(s) 110 during workload assignment process 204. Workload instructions 208 may contain any or all information (e.g., any of the information and/or data as discussed above in reference to FIGS. 1B and 2A) required for the AI workload engine(s) 112 to complete execution of the workload specified in workload request 202.

Upon receiving workload instructions 208 the respective AI workload engine(s) 112 may perform workload execution process 210 to fulfill (e.g., perform, execute, complete, or the like) the workload included in workload request 202.

Turning now to FIG. 2B, once the workload execution process 210 is completed, the respective AI workload engine(s) 112 may generate workload completion notice 212 and provide (e.g., transmit) the workload completion notice 212 back to one, some, or all of the resource orchestrator architect engine(s) 110.

Upon receiving the workload completion notice 212, the resource orchestrator architect engine(s) 110 may use the workload completion notice 212 in workload completion archive process 214 to archive (e.g., document) the completion of the workload. In particular, as part of workload completion archive process 214, the resource orchestrator architect engine(s) 110 may generate workload completion data 218 and transmit (e.g., append) the workload completion data 218 to blockchain 201. In embodiments, the workload completion data 218 may include the shared resource blockchain logs 107 used to document the completion of the workload along with all of the processes and resources used to complete (e.g., fulfill) the workload. Workload completion data 218 may also include any other data (discussed or not discussed above in reference to FIGS. 1B and 2A) that could be used to show (e.g., represent, present, or the like) the processes and resources used to complete (e.g., fulfill) the workload.

Resource orchestrator architect engine(s) 110 may use the workload completion notice 212 in workload completion archive process 214 to generated update workload completion notice 216 that is subsequently provided (e.g., transmitted) back to the request source 200 where the update workload completion notice 216 is presented (e.g., displayed on a display) to the user that submitted the initial workload request 202. In embodiments, the update workload completion notice 216 may be identical to the workload completion notice 212. Alternatively, the update workload completion notice 216 may be a stripped down (e.g., summarized) or expanded (e.g., amended to include additional explainability) version of the update workload completion notice 216. The stripping down and/or expansion of the workload completion notice 212 into the update workload completion notice 216 may be based on, for example, a pre-stored preference of the user relating to how the user usually prefers (e.g., likes) to have such completion data presented to him/her.

Any of the processes illustrated using the second set of shapes (shown in FIGS. 2A and 2B) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2B may perform various methods for machine generated data conversion using an on-device idle NPU resource utilization process. FIG. 3 illustrates an example of a method that may be performed by the components of FIGS. 1A-2B. For example, any of the data processing systems 101A-101N may perform all or a portion of the methods. In the diagrams discussed below and shown in FIG. 3, any of the operations may be repeated, performed in different orders, and/or performed in parallel with or in a partially overlapping in time manner with other operations.

Starting at Operation 300 and as discussed above in reference to FIGS. 2A-2B, a data processing system (namely, a resource orchestrator architect engine of the data processing system) may obtain a workload request (e.g., 202, FIG. 2A).

In Operation 302, and as discussed above in reference to FIGS. 1B-2B, the resource orchestrator architect engine (individually or cooperatively with resource orchestrator architect engines) may perform a workload assignment process (e.g., process 204 discussed above in FIG. 2A) using one or more workload assignment factors to obtain workload instructions (e.g., 208, FIG. 2A) and at least one data processing system (among data processing systems that are sharing computing resources within a distributed system/shared computing system of embodiments disclosed herein) to which the workload request is to be assigned.

In embodiments, the at least one data processing system hosts one or more AI workload engines (e.g., 112, FIGS. 1B-2B) that have been determined as being capable and/or the most optimal for fulfilling the workload request.

In Operation 304, and as discussed above in reference to FIGS. 1B-2B, the resource orchestrator architect engine may cause the at least one data processing system to fulfill the workload request using the workload instructions.

In Operation 306, and as discussed above in reference to FIGS. 1B-2B, the resource orchestrator architect engine may obtain, after the at least one data processing system has completed fulfillment of the workload request, a workload completion notice (e.g., 212, FIG. 2B) from the at least one data processing system.

In Operation 308, and as discussed above in reference to FIGS. 1B-2B, the resource orchestrator architect engine may perform one or more actions (e.g., one or more actions associated with workload completion archive process 214 discussed in reference with FIG. 2B) to archive the workload completion notice (e.g., for future use, for traceability, for transparency, or the like) of the workload completion notice.

The process of FIG. 3 may end following Operation 308.

Although embodiments disclosed herein have been described using a local, on-device/intranet setting, they are not limited to such a configuration. Namely, embodiments disclosed herein may also be applied to a network setting where idle NPU resources are shared (e.g., rented, sold, used in cooperatively, or the like) between data processing systems of different environments (e.g., 100, FIG. 1A) separated by the network (e.g., communication system 104 of FIG. 1A). For example, the idle NPU resources of data processing systems 101A-101N of environment 100 may be shared (e.g., rented out, shared with, used cooperatively with, sold to, etc.) with any of the other environments 102 that are separated from environment 100 by communication system 104. Said another way, the idle NPU resources of environment 100 may be provided to the other environments 102 in an as-a-service (aaS) manner, similar to a digital idle NPU resource marketplace setting.

Additionally, although idle NPU resources are specifically mentioned herein, embodiments disclosed herein are not limited to the use of these idle resources. More specifically, non-idle resources of NPUs (and/or even idle and/or non-idle resources of CPUs and GPUs of the data processing system) may also be used without departing from the scope of this invention. Other types of processing units (e.g., data processing units (DPUs), language processing unit (LPU), tensor processing units (TPUs), or the like) may also be used to execute the processes and methods of embodiments discussed herein.

Furthermore, although LLMs are specifically mentioned throughout this disclosure, one having ordinary skill in the art would appreciate that any other types of generative AI models (e.g., multi-modal models that handle text, images, and videos; generative adversarial networks (GANs); or the like) may also be used instead of LLMs without departing from the scope of embodiments disclosed herein.

Even further, the distributed system/shared computing system of embodiments disclosed herein may be implemented as an online neural marketplace for NPU (or other computing) resources. This neural marketplace may (using the above features of embodiments disclosed herein) be configured as a platform that enables customers to sell or rent out their unused or idle NPU capacity in a non-intrusive, optimized, and environmentally friendly manner. This allows other customers to purchase the additional NPU capacity to handle extra AI workloads, as well as various AI/ML and data services running over distributed NPUs—including specialized and certified AI/LLM agents. The entire process is managed through specialized/certified AI agents (e.g., the resource orchestrator architect engine(s) 110), while ensuring complete transparency of resource usage for all parties involved (e.g., via archiving all workload related data on a blockchain environment).

In this neural marketplace, idle NPUs and the refined data they generate are transformed into tradable assets. This neural marketplace does not just trade in computational resources but also in the valuable insights derived from high-quality processed data, creating a symbiotic environment where data and processing capabilities are commodities that fuel a new economic paradigm. Additionally, this neural marketplace is underpinned by an inventive incentive mechanism. Users are rewarded with digital currencies (e.g., cryptocurrencies or the like) for contributing their data to a communal pool and allowing their NPUs to engage in idle data processing. This integration with blockchain technology guarantees security and transparency, fostering a trust-based community devoted to the shared economy of data and processing power. The result is a self-sustaining marketplace that rewards participation and fuels the collective growth of the network's intelligence and capability. Even further, this neural marketplace may also be used by companies as a vehicle for supporting non-profits, charitable organizations or other entities, such as start-ups, by donating their unused/idle NPU capacity into the neural marketplace.

Any of the components illustrated in FIGS. 1A-3 may be implemented with one or more computing devices. Turning to FIG. 4, a block diagram illustrating an example of a computing device (also referred to herein as “system 400”) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system-on-a-chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing shared computing resources of data processing systems, the method being performed by a first data processing system of the data processing systems and comprising:
obtaining a workload request;
performing a workload assignment process using one or more workload assignment factors to obtain workload instructions and at least one data processing system of the data processing systems to which the workload request is to be assigned, the one or more workload assignments factors being obtained at least from:
a smart contract stored on a blockchain, and
resource orchestration architect agents deployed across the data processing systems; and
causing, by the first data processing system and through providing the workload instructions to the at least one data processing system, the at least one data processing system to fulfill the workload request.

2. The method of claim 1, wherein the shared computing resources comprise Natural Processing Unit (NPU) computing resources configured for execution of artificial intelligence (AI) related workloads, the NPU computing resources being provided by one or more NPUs installed in each of the data processing systems.

3. The method of claim 2, wherein the NPU computing resources are registered as being idle.

4. The method of claim 3, wherein the one or more workload assignment factors comprise an environmental impact associated with execution and completion of a workload specified in the workload request by the at least one data processing system.

5. The method of claim 4, wherein the environmental impact is quantified based on an amount of energy consumption and an estimated carbon dioxide emission required for the execution and completion of the workload.

6. The method of claim 4, wherein the one or more workload assignment factors further comprise a skill assessment of each of the one or more NPUs.

7. The method of claim 4, wherein the one or more workload assignment factors further comprise optimization requirements specified in the workload request, the optimization requirements being defined by a user associated with the workload request and comprise requirements based on at least speed, accuracy, and environmental impact associated with the execution and completion of the workload.

8. The method of claim 4, wherein the smart contract dynamically performs real-time adjustments to one or more factors used to determine the environmental impact and provides the one or more factors that are adjusted in real-time to the first data processing system while the first data processing system is performing the workload assignment process.

9. The method of claim 1, further comprising:
obtaining, from the at least one data processing system, a workload completion notice comprising workload completion data; and
archiving the workload completion data onto the blockchain.

10. The method of claim 9, wherein the workload completion data that is archived onto the blockchain comprises a description of a workload completed by the at least one data processing system, an amount of and identification (ID) information of hardware resources associated with the shared computing resources used by the at least one data processing system to complete the workload, and an environmental impact factor associated with completion of the workload.

11. A non-transitory machine-readable medium having instructions stored therein, which when executed by a processor of a first data processing system among data processing systems, cause the processor to perform operations for managing shared computing resources of the data processing systems, the operations comprising:
obtaining a workload request;
performing a workload assignment process using one or more workload assignment factors to obtain workload instructions and at least one data processing system of the data processing systems to which the workload request is to be assigned, the one or more workload assignments factors being obtained at least from:
a smart contract stored on a blockchain, and
resource orchestration architect agents deployed across the data processing systems; and
causing, by the first data processing system and through providing the workload instructions to the at least one data processing system, the at least one data processing system to fulfill the workload request.

12. The non-transitory machine-readable medium of claim 11, wherein the shared computing resources comprise Natural Processing Unit (NPU) computing resources configured for execution of artificial intelligence (AI) related workloads, the NPU computing resources being provided by one or more NPUs installed in each of the data processing systems.

13. The non-transitory machine-readable medium of claim 12, wherein the NPU computing resources are registered as being idle.

14. The non-transitory machine-readable medium of claim 13, wherein the one or more workload assignment factors comprise an environmental impact associated with execution and completion of a workload specified in the workload request by the at least one data processing system.

15. The non-transitory machine-readable medium of claim 14, wherein the environmental impact is quantified based on an amount of energy consumption and an estimated carbon dioxide emission required for the execution and completion of the workload.

16. A first data processing system among data processing systems, the first data processing system comprising:
a central processing unit (CPU); and
a memory coupled to the CPU to store instructions, which when executed by the CPU, cause the CPU to perform operations for managing shared computing resources of the data processing systems, the operations comprising:
obtaining a workload request;
performing a workload assignment process using one or more workload assignment factors to obtain workload instructions and at least one data processing system of the data processing systems to which the workload request is to be assigned, the one or more workload assignments factors being obtained at least from:
a smart contract stored on a blockchain, and
resource orchestration architect agents deployed across the data processing systems; and
causing, by the first data processing system and through providing the workload instructions to the at least one data processing system, the at least one data processing system to fulfill the workload request.

17. The first data processing system of claim 16, wherein the shared computing resources comprise Natural Processing Unit (NPU) computing resources configured for execution of artificial intelligence (AI) related workloads, the NPU computing resources being provided by one or more NPUs installed in each of the data processing systems.

18. The first data processing system of claim 17, wherein the NPU computing resources are registered as being idle.

19. The first data processing system of claim 18, wherein the one or more workload assignment factors comprise an environmental impact associated with execution and completion of a workload specified in the workload request by the at least one data processing system.

20. The first data processing system of claim 19, wherein the environmental impact is quantified based on an amount of energy consumption and an estimated carbon dioxide emission required for the execution and completion of the workload.
